(19) United States
(12) Patent Application Publication
(10) Pub. No.: US 2015/0284550 A1
(43) Pub. Date: Oct. 8, 2015

(54) Tunable Surface Topography Through Particle-Enhanced Soft Composites

(71) Applicant: Massachusetts Institute of Technology, Cambridge, MA (US)

(72) Inventors: Mark Andrew Guttag, Lexington, MA (US); Mary C. Boyce, New York, NY (US)

(73) Assignee: Massachusetts Institute of Technology, Cambridge, MA (US)

(21) Appl. No.: 14/516,101

(22) Filed: Oct. 16, 2014

Related U.S. Application Data
(60) Provisional application No. 61/893,336, filed on Oct. 21, 2013.

(51) Int. Cl. C08L 21/00

(52) U.S. Cl. CPC C08L 21/00

(57) ABSTRACT

Composite material. The material included a matrix of a deformable material having a first stiffness and particles having a second stiffness different from the first stiffness are embedded near a surface of the matrix wherein a deformation of the matrix induces a change in topography of the surface. The particles may be stiffer or softer than the matrix material.

This patent application claims priority to provisional patent application Ser. No. 61/893,336 filed on Oct. 21, 2013, the contents of which are incorporated herein by reference in their entirety.

### BACKGROUND OF THE INVENTION

This invention relates to composite materials and more particularly to a composite of a deformable matrix with particles having a different stiffness from the matrix embedded therein near a surface. Deformation of the matrix causes changes in surface topography.

It is known that when a stiff film is attached to a soft substrate the structure will wrinkle as a result of buckling (Allen, 1969) under compressive stress. one limitation to wrinkling is the fact that it is difficult to control the shape and distribution of localized surface features. Cabuz et al. (Cabuz et al., 2001) developed a method to get around this issue. Their method uses a combination of electrostatic and pneumatic forces to control the surface topography. They mount a flexible cover on top of a series of cavities. The cavities are then filled with some sort of working fluid (either liquid or gas) and the shape of the cavities are controlled by a series of electrostatic electrodes used as electrostatic actuators. This method has the advantage that it allows for individual control of the cavities and thus localized control of the surface topography. However, this method has drawbacks including the fact that is requires electrical circuitry throughout the whole sample.

Another method for creating tunable surface topography uses the responsive behavior of hydrogels (Sidorenko et al., 2007). They combined an “array of isolated high-aspect-ratio structures” (AIRS) with a hydrogel to form what they call hydrogel-AIRS or HAIRS. These rigid structures were made of silicon nanocolumns. Their method makes use of the swelling behavior of hydrogels when exposed to water to activate the surfaces. When the HAIRS are dry the nanocolumns rest at angles between 60°-70° to vertical, however when exposed to humidity the hydrogel swells causing the nanocolumns to reorient themselves. Depending on the amount of humidity, the nanocolumns can reach anywhere from the dry rest angle all the way to vertical. When the hydrogel is dried out the nanocolumns return to their initial position, so the process is fully reversible. Also this method relies on the swelling of hydrogels as the actuation method, which means that the humidity of the environment must be controlled.

Another method to create tunable surface topography uses elastomeric materials to create structures with periodic and random arrangements of voids with a thin-film of the same elastomer on top of the structure (Kozlowski, 2008). Kozlowski found that when the structure underwent uniaxial compression the film would form convex domes over the voids in the base structure. Since the material is elastomeric, it can be assumed that upon unloading, the structure would recover its initial shape, meaning that it is a fully reversible process.

### SUMMARY OF THE INVENTION

The composite material of the invention includes a matrix of a deformable material having a first stiffness. Particles having a second stiffness different from the first stiffness are embedded near a surface of the matrix wherein a deformation of the matrix induces a change in topography of the surface. In this parent application, the phrase “near a surface” means within approximately a diameter of one of the embedded particles below the surface.

The particles that are embedded below the surface are stiffer or softer than that of the matrix. The embedded particles may be distributed within the matrix either randomly or in an ordered array. The composite material disclosed herein may form a two-dimensional system or a three-dimensional system.

In preferred embodiments, the particles may have shapes such as circular, rectangular, triangular, polygonal or elliptical rods or plates. For a three-dimensional embodiment, the particles may be spherical, ellipsoidal tetrahedral or prismatic.

In another embodiment, the deformation of the matrix is uniaxial, biaxial or a complex three-dimensional deformation state. In a preferred embodiment, the matrix material and the particles are selected to tune shape, amplitude and/or frequency of a waveform on the surface. It is preferred that the matrix material be elastomeric.

The tunable surface topography of the invention can change light reflection or absorption to change the appearance of the surface. Surface roughness may be controlled in a fluid flow situation to control the flow. The tunable surface topography can also be adapted to change the coefficient of friction of the surface to provide tunable friction control.

The present invention thus provides a composite material such that deformation of the composite material serves to control the surface topography by creating deformation fields within the composite that change the surface geometry of the composite. By varying the size, shape and distribution of the embedded particles located below the surface of the composite, different surface topographies are achievable.

### BRIEF DESCRIPTION OF THE DRAWING

FIG. 1a is a schematic view of a particle-enhanced soft composite (PESC) in an undeformed state.

FIG. 1b is a schematic illustration of the composite of FIG. 1a after compression at 20% global strain.

FIG. 2 shows several representative volume elements (RVE) used for simulations and their corresponding unit cells.

FIG. 3 illustrates a general example of periodic boundary conditions on two surfaces.

FIG. 4 is a graph of true stress against true strain providing an experimental validation of the neo-Hookean material model.

FIG. 5a and b illustrate validation of mesh density for the simulations described herein.

FIG. 6 is a schematic representation of a composite material showing important dimensions for a uniform array of particles.

FIG. 7 are simulation results showing the effect of a particular dimensionless parameter on surface topography.

FIG. 8 is a graph of peak amplitude versus global compressive strain for different dimensionless parameter values.

FIG. 9 are illustrations of strain contours of different relative inter-particle ligament lengths shown at 20% global compressive strain.

FIG. 10a and b are schematic diagrams of matrix extrusion due to shearing.

FIG. 11 illustrates the effect of the number of rows of particles on surface topography.

FIG. 12 is a graph of peak amplitude versus number of rows showing normalized peak amplitude against the number of rows of particles.

FIG. 13 shows dimension for the investigation of the effect of particle aspect ratio.

FIG. 14 illustrates the effect of aspect ratio of the particles on surface topography.

FIG. 15 shows normalized peak amplitude versus aspect ratio of the particles.

FIG. 16a shows the effect of rotating particles on surface topography with α/β equal 0.15 and 0.21.

FIG. 16b is a graph of peak amplitude versus global compressive strain for α/β equal to 0.15.

FIG. 17a, b, e, d, e and f are several simulations of both uniform and non-uniform arrays of particles showing the effect of surface topography for non-uniform arrays of particles.

FIG. 18 is a simulation result of a composite material demonstrating localizability of topographical features of a non-uniform array of particles.

FIGS. 19a and b illustrate the effect of compressibility of the matrix on surface topography at 20% global compressive strain.

FIG. 20a and b are simulations comparing strain for relatively incompressible and compressible cases of different relative inter-particle ligament lengths.

FIG. 21 illustrates the effect of varying the stiffness of the particles on surface topography in which the Young's modulus of the matrix is 1 MPa for each simulation.

FIG. 22 is a perspective view of a typical experimental setup for observing topographical changes in the composite material.

FIG. 23 are illustrations comparing simulation and experiments of full RVE.

FIG. 24a, b and c show comparisons of simulation and experimental results for PESCs with different number of rows of particles.

FIG. 25a, b, c and d show a comparison of simulation and experimental results for PESCs with non-uniform arrays of particles.

### DESCRIPTION OF THE PREFERRED EMBODIMENT

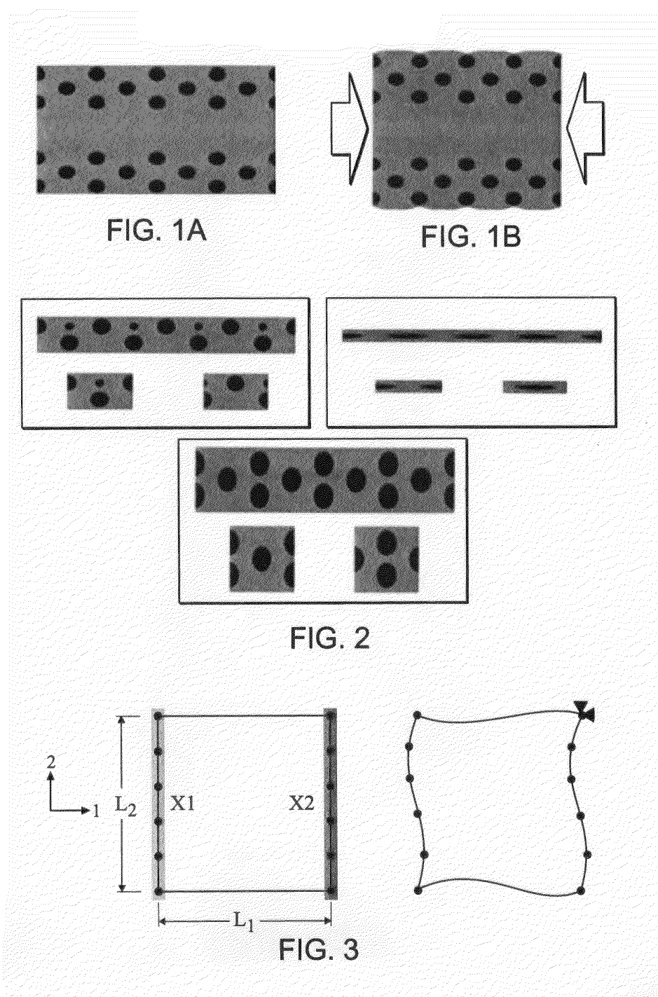

We simulated several different particle distributions. In each simulation, the particle enhanced soft composites (PESCs) were made up of a soft matrix with stiff particles embedded below the surface. While we varied the size, shape and arrangement of the particles from simulation to simulation, we kept many features the same for all the simulations. Each sample was composed of two arrays of particles that were symmetric about the horizontal central axis (FIG. 1). The space between the two arrays was sufficiently large that neither array affects the other. The PESCs were all of a similar size with the particles and the inter-particle spacing on the order of 1 cm.

All simulations were run using the commercially available FE software Abaqus 6.11. In each simulation, periodic boundary conditions were applied to the left and right side of the PESC. Using periodic boundary conditions ensures that each simulated PESC can be seen as a representative volume element (RVE) that could be repeated over and over. A displacement boundary condition was applied to the left and right sides, causing the sample to be compressed to 20% global strain linearly ramped over the course of the loading step (FIG. 1b). In all of the simulations, the top and bottom surfaces were left free to deform, since those are the surfaces of interest.

The use of periodic boundary conditions allowed us to simulate the behavior of a large sample while saving on computation by using a smaller RVE. Some of the RVEs analyzed in this thesis are shown in FIG. 2. The figure also shows the unit cells associated with each RVE. Each of the geometries shown has two different unit cells, and the RVEs were 4 of the first unit cells shown. Simulating a single unit cell would be sufficient to give the response of the PESC. For easy visualization and post processing, we chose to conduct simulations with multiple unit cells.

A methodology for the implementation of general three-dimensional periodic boundary conditions for repeating structures was developed by Danielsson, Parks and Boyce (Danielsson et al., 2002). A simplified version of their methodology was used in our work because the periodic boundary conditions were two-dimensional and only needed to be applied on two surface. FIG. 3 shows an example of the general periodicity of the deformation of the two surfaces. The nodes on the left side are defined to be a set X1 while the nodes on the right side are defined to be a set X2.

The periodic boundary condition was defined mathematically to prescribe a relationship between the “1” (horizontal) degree of freedom of X1 and X2 and the “2” (vertical)degree of freedom of X1 and X2 in Equation 2.

u₁^{X2}−u₁^{X1}=H_{1X}L₁ u₂^{X2}−u₂^{X1}=H_{2X}L₂ (2)

In these equations, u₁^{Xj} is the displacement in the i-direction of each node in the j^{th} node set, H₁₁ and H₂₁ are the elements of the displacement gradient tensor (

$$( {H}_{ij} = \text{?} \\ \text{?} \text{indicates text missing or illegible when filed}$$

where X₁ is the specific original position), and L₁ and L₂ are the lengths of the RVE shown in FIG. 3. In this patent application all of the simulations were run under axial compression in the 1-direction. The displacements H₁₁ and H₂₁ were defined in the simulations using virtual nodes. The virtual nodes are nodes that are not part of the mesh representing the PESC. The nodes were given displacements of H₁₁=−0.2 and H₂₁=0. Using those values in Equation 2 induced axial compression of 20% global strain in the 1-direction. It was also necessary to fix the displacement of a single node so that the entire sample would not undergo translation. The way we have implemented the periodic boundary condition fixing the displacement of a single node also prevents rotation of the system. Since we set H₂₁=0 the nodes of the X1 set are unable to move vertically relative to the nodes of the X2 set and thus no rotation of the system is allowed. In this thesis the stationary node was selected to be the top right node, as shown in the deformed configuration in FIG. 3.

It is important to assign realistic material properties to both the particles and the matrix in the PESCs. A compressible neo-Hookean constitutive model was selected for both the particles and the matrix. The neo-Hookean model used in Abaqus is described using a strain energy potential, as shown in Equation 3a.

$$( a ) U = {C}_{10} ( {\overline{I}}_{1} - 3 ) + \frac{1}{{D}_{1}} {( J - 1 )}^{2} \\ ( b ) G = 2 {C}_{10} \\ ( c ) K = \frac{2}{{D}_{1}} \\ ( d ) B = F \cdot {F}^{T} \\ ( e ) j = \sqrt{det B} \\ ( f ) {\overline{I}}_{1} = \frac{trace ( B )}{{J}^{2 / 3}} \qquad ( 3 )$$

The first term in Equation 3a (with T₁ in it) corresponds to the energy stored due to isochoric change of shape. The second term in Equation 3a (with j in it) corresponds to the energy stored due to change of volume. The bulk, K, and shear, G, moduli are related to the variables D₁ and C₁₀ as shown in Equations 3b and c. The variables T₁ and j are defined using the left Cauchy-Green deformation tensor, B. the Cauchy-Green deformation tensor is defined using the deformation gradient, F(

$$( {H}_{ij} = \text{?} , \\ \text{?} \text{indicates text missing or illegible when filed}$$

where xᵢ is the current position and xᵢ is the original position), and its transpose F^{T}, as given in Equation 3d. The term l is the volume ratio and is defined by Equation 3e. The term T₁ is called the first deviatoric strain invariant, and is defined by Equation 3f.

The compressible neo-Hookean model requires a bulk modulus and a shear modulus. The values for the bulk and shear moduli used in most of the simulations were based on the properties of the materials that were available in the 3D printer that was used for the physical experiments. In some simulations, described later, we explored the effects of other material properties. The bulk and shear moduli of the 3D printed materials were estimated by experimentally determining the elastic modulus and estimating the Poisson's ratio. The measured elastic modulus of the matrix and particles were approximately 1 MPa and 1.5 GPa respectively. We assumed that both the matrix and the particle materials were nearly incompressible with Poisson's ratios of 0.499 and 0.490 respectively. Using these values, we calculated a bulk and shear moduli for both the matrix and the particles, Table 1.

TABLE 1
Material properties used for most simulations

| | G (MPa) | K (MPa) |
|---|---|---|
| Matrix | 0.33 | 166.7 |
| Particles | 500 | 25000 |

As Table 1 shows, in the simulation the bulk modulus for the matrix is about 500 times larger than the shear modulus. In reality the ratio of the bulk modulus to the shear modulus (K/G) is probably much larger since the bulk modulus is likely actually greater than 1 GPa. However, using a more realistic bulk modulus increases the computational time dramatically. After running simulations with several different bulk moduli we found that increasing the ratio K/G by a factor of 10 had negligible effects on the results of the strain distribution and topography. This led us to conclude K/G equal to approximately 500 is large enough to be accurate while being small enough to keep the computational time reasonably short.

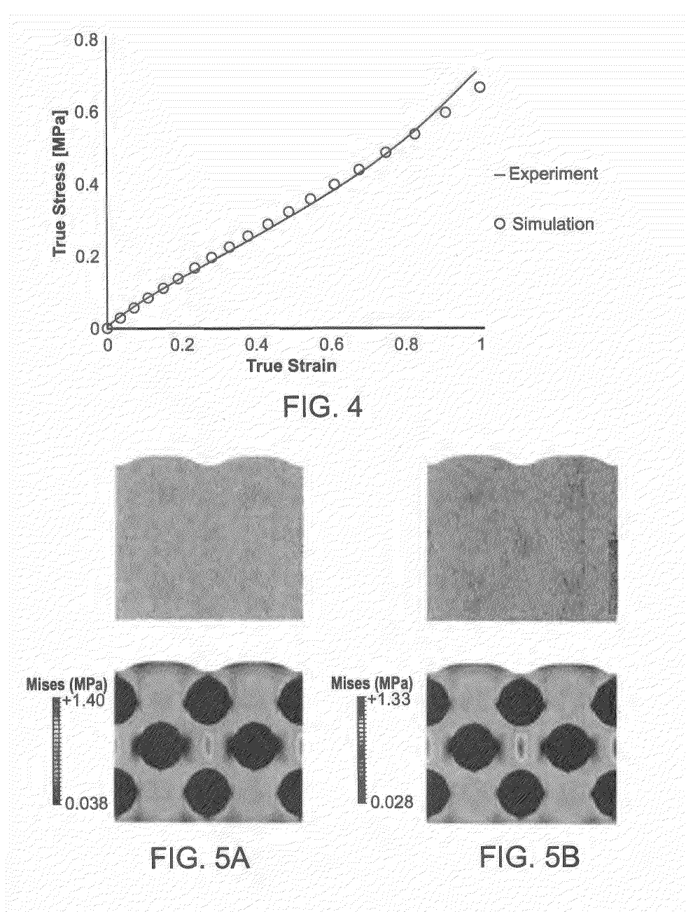

The compressible neo-Hookean model was chosen in large part because of its computational simplicity. However, there was good agreement between simulations with the neo-Hookean model, and physical experiments with the 3D printed materials. In physical compression experiments with the matrix material Dr. Hansohl Cho was able to create a true stress vs. true strain curve (FIG. 4). Comparing the experiments to simulations shows that the neo-Hookean model for the matrix material is reasonably accurate up to 100% true strain.

Meshing of the geometry of particles within a matrix was done using meshing algorithms within Abaqus. The mesh density was defined by applying a global seeding to all edges. Different seed densities were tested for a few select simulations in order to determine the smallest mesh density that still gave stable results. The final mesh density was chosen by selecting a value of the global seeding that when doubled changed the maximum resultant von Mises stress by less than 5% (FIG. 5). We performed the meshing in Abaqus with the element shape defined as “Quad-dominated”, the technique was “Free” and we used the “advanced front” algorithm. These were all built in meshing options in Abaqus. The particles were modelled to be perfectly bonded to the matrix.

Selecting the element shape as quad-dominated made the mesh into a mixture of quadrilateral and triangular elements. In all simulations, unless otherwise specified, the elements were of the plane strain family. We did this because of the plane strain nature of the physical experiments that will be presented later. The majority of simulations used linear, reduced integration elements. These types of elements were CPE4R and CPE3 (quadrilateral and triangular respectively). In some cases when the simulation was unable to converge to a solution with the types of elements described above, the elements were changed to plane strain quadratic elements (CPE8 and CPE6M). These types of elements were not used for the majority of the simulations because that would have dramatically increased the computational time without increasing the accuracy of the results.

For all the simulations, the step type was “Static, General” with non-linear geometry. We used non-linear geometry because of the large deformations and corresponding large changes in geometry as well as the nonlinear behavior of the material.

We define a uniform array as an array of particles in which all the particles are the same size and are distributed in a periodic arrangement. We present geometries in a dimensionless way by computing ratios of geometric features relative to one reference feature.

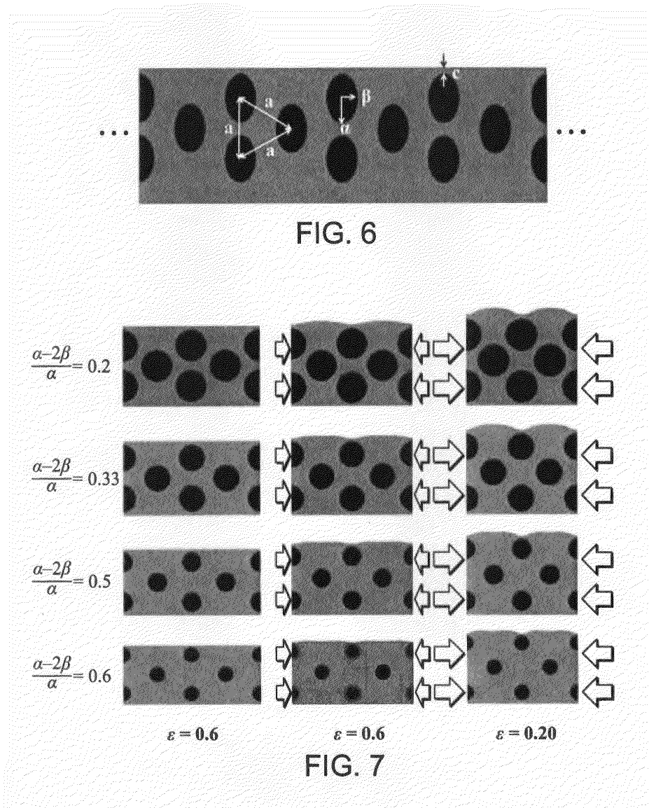

All of the PESCs examined are made up of hexagonal arrays of ellipsoidal particles. FIG. 6 shows the important dimensions that will be referred to in this section; a is spacing of the hexagonal array, α is the size of the particle axis perpendicular to the surface, β is the size of the particle axis parallel to the surface, and c is the distance between the first row of particles and the surface.

The first dimensionless geometric parameter that will be investigated in this section is (a-2β)/a. That parameter represents the relative inter-particle ligament length and, for the case of circular particles, a (a-2β)/a is a inter-particle ligament length. The second parameter that will be investigated is the number of rows of particles. The last dimensionless parameter that will be investigated in this section will be α/β, which is the aspect ratio of the particles. To systematically investigate the effect of each of these parameters, a number of other dimensionless parameters were held constant. These parameters will be discussed in more detail below.

The relative inter-particle ligament length is defined by the dimensionless parameter

$$\frac{a - 2 β}{a} .$$

In the investigation of the effect of this parameter on the surface topography, other parameters were held constant. The aspect ratio of the particles (α/β) was held at a constant value of 1, meaning that the particles were all circular. The parameter c/β was held at a constant value of 0.2, meaning that the distance between the particles and the surface was 5 times smaller than the radius of the particles. In this section, we set the number of rows of particles to 3.

The parameter

$$\frac{a - 2 β}{a}$$

was varied between the values of 0.2 and 0.6, and in all simulations the PESCs were compressed to 20% global strain. The parameter

$$\frac{a - 2 β}{a}$$

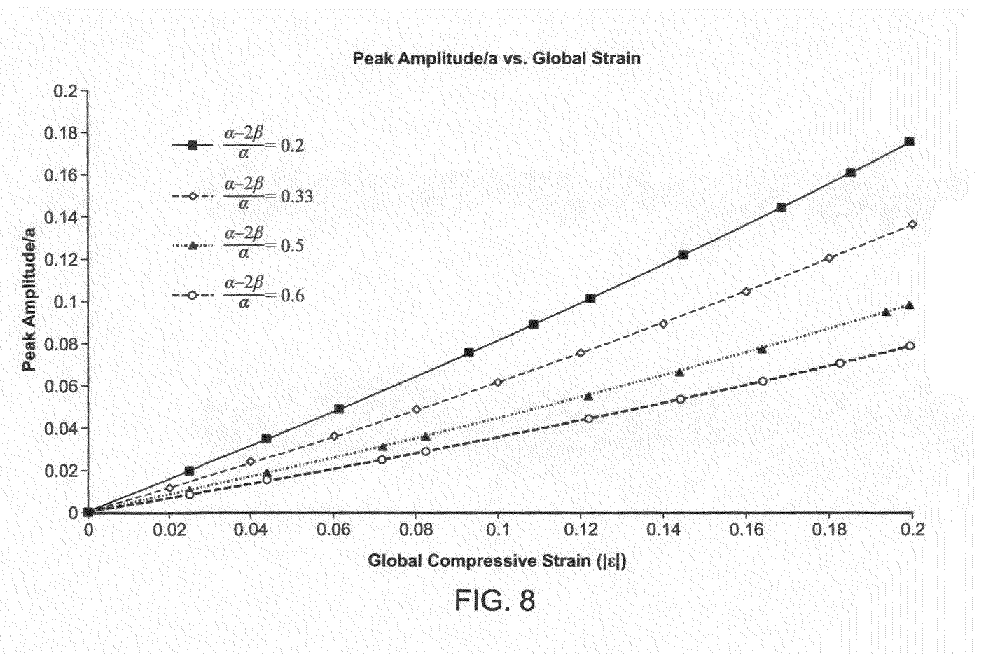

was modified by changing the value of β and holding the value of the hexagonal spacing constant. FIG. 7 shows the results of simulations with 4 different relative inter-particle ligament lengths at global compressive strains of 0%, 10% and 20%. The first thing to notice in the figure is that as the PESCs are compressed the surface transitions smoothly from the initial flat state to the final shape without an instability occurring. This is a feature that distinguishes the PESCs from other methods of creating reversible surface topography, such as wrinkling, which are driven by instabilities. The smooth transition of the surface shape is important because it means that the loading can be stopped at any point to get an intermediate surface shape. FIG. 8 shows the normalized peak amplitude (where peak amplitude is the vertical distance from the highest point on the surface to the lowest point on the surface) graphed against the global strain for the PESCs with different relative inter-particle ligament lengths. The graph verifies that the surface changes smoothly as the global strain is changed. The normalized peak amplitude vs. global strain curves are fit perfectly by a quadric (shown by the dotted lines). We do not yet understand the reason for the quadratic fit.

Another feature present in each simulation shown in FIG. 7 is the minimum heights of the surfaces are aligned directly above the particles in the first row. This occurs above the first row of particles in all of the PESCs that have been examined as part of this research. These global minima are always aligned directly above the particles in the first row because the particles near the surface constrain the deformation of the matrix and act as what we call a “pinning region”.

Looking at the top right image in FIG. 7, we see that between the pinning regions the surface topography has a single large peak. This peak is aligned directly above the particles in the second row. As

$$\frac{a - 2 β}{a}$$

is increased to a value of 0.33, there is still a single peak aligned directly above the particles in the second row; however the peak appears to be a bit flatter than with the smaller relative inter-particle ligament length. When the relative inter-particle ligament length is increased to a

$$\frac{a - 2 β}{a}$$

value of 0.5 or greater, there is no longer a single peak located above the particles in the second row. Instead what appears is a local minimum aligned at the location. We refer to these local minima aligned above the particles in the second row as “bisected peaks.”

To understand why the bisected peaks only appear for larger values of

$$\frac{a - 2 β}{a} ,$$

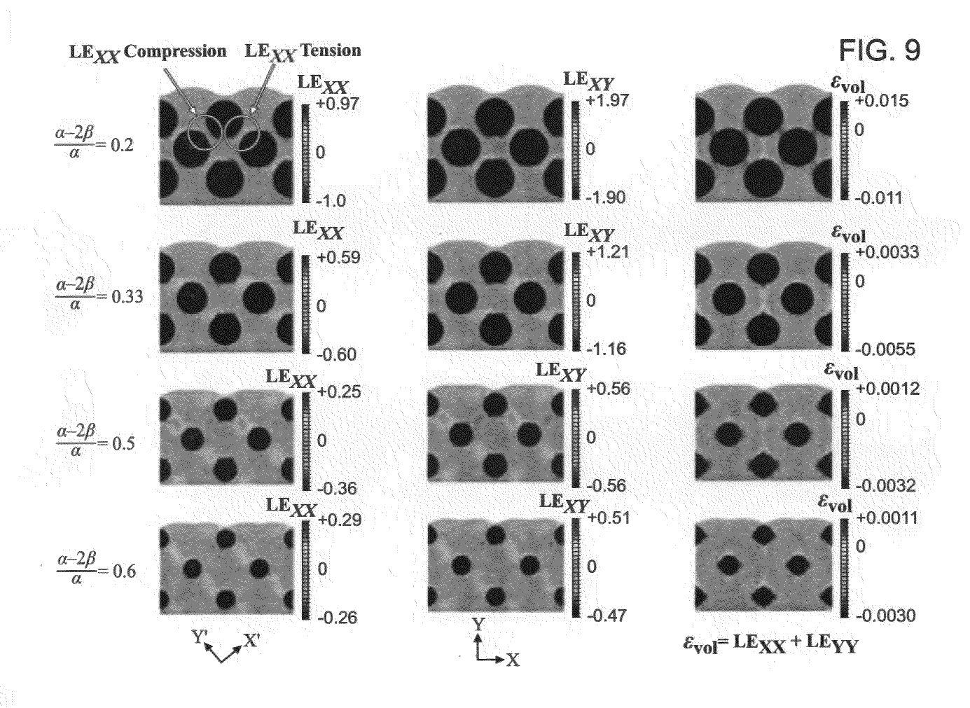

the mechanics of the deformation needs to be understood. FIG. 9 shows strain contours for different cases of relative inter-particle ligament lengths. The first column in the figure is the normal strain represented in terms of the X′-Y′ coordinate frame, the second column is the shear strain in the X-Y coordinate frame, and the third column is the volumetric strain. The strain displayed in the images in the first column corresponds to inter-particle shear strain in the matrix. Notice the alternating tensile LE_{X′X′} and compressive LE_{X′X′} in the matrix at each inter-particle matrix bridging. This implies that the global compressive strain being applied to the PESC is being accommodated primarily by local inter-particle shear strain in the matrix. The fact that the strain in the matrix is primarily shear strain occurs because the matrix is nearly incompressible, so the global compression causes shape change primarily through inter-particle shear in the PESC rather than volume change. When we compare the magnitude of the volumetric strain to the magnitude of the shear strain shown in the contours of FIG. 9, we see that the volumetric strain is orders of magnitude smaller than the shear strain. In the figure, the strain in the particles is not shown because they hardly deform, and instead move as rigid bodies.

Further examination of FIG. 9 reveals that the shear strain is concentrated primarily in the inter-particle ligaments. This is especially true for the case of the smaller ligaments, where well defined shear bands appear. It is clear from the figure that there is a significant difference in the magnitude of strain for different inter-particle ligament lengths. The magnitude of strain is much larger for the smaller values than the larger values of

$$\frac{a - 2 β}{a} .$$

This is because the larger the inter-particle ligament, the more the shear is dispersed throughout the matrix causing a lower magnitude of shear strain.

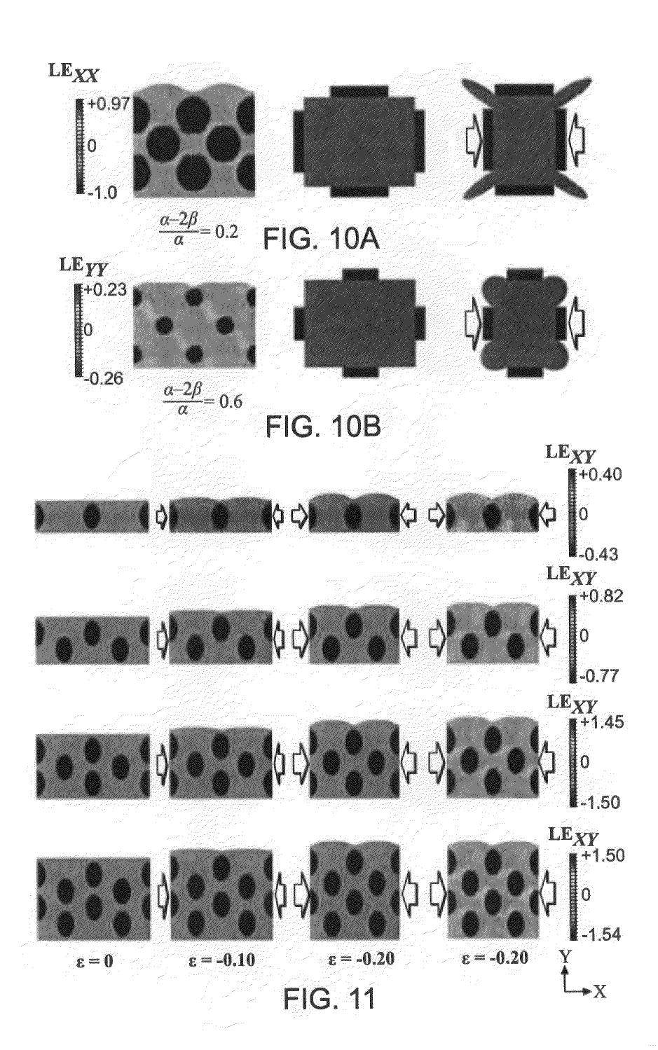

FIG. 10 helps to explain how the difference in magnitude of shear strain in the matrix leads to different surface topographies. In general what happens is that the concentrated inter-particle shearing that was seen in FIG. 9 (and again in the left most images of FIG. 10) leads to the matrix being extruded through the inter-particle ligaments into the region below the surface. FIG. 10a shows that when the inter-particle ligaments are smaller, the higher magnitude of shear strain causes the matrix to be extruded from the region between the particles in the second row far out into the region directly below the surface between the particles in the first row. For these smaller inter-particle ligaments, the extrusions from two adjacent regions merge together above the particles in the second row and push the surface up to form the single large peak. FIG. 10b also shows that when the inter-particle ligaments are larger and the shear strain is more dispersed so the magnitude is less, the matrix does not extrude as far into the region below the surface. Under these conditions the two extruded regions do not merge together to push the surface up.

To investigate the effect of the number of rows of particles on the surface topography we arranged the particles in a hexagonal array similar to that used in the investigation of the effect of the inter-particle ligament length. The important geometric dimensions used in this section are the same as those seen in FIG. 6. The parameter c/α was held at a constant value of 0.25, which means that the ratio of the distance between the particles and the surface to the size of the particles was unchanged. The aspect ratio of the particles (α/β) was set to a constant value of 1.5. We set the relative inter-particle ligament length

$$( \frac{a - 2 β}{a} )$$

to a constant value of 0.467. The value of the relative inter-particle ligament length was set by choosing both a constant hexagonal spacing (a) and a constant semi-minor axis of the particles (β).

FIG. 11 shows the results of simulations at 0, 10%, and 20% global compressive strains. In the figure the only parameter that is changed is the number of rows of particles in the PESC. In the top row of the figure, in which the PESC has a single row of particles, the surface develops a series of single large peaks aligned between the particles in the first row. When a second row of particles is added (the second row of FIG. 11), the surface takes on an overall flatter shape. The single large peak we saw for a single row of particles is replaced by a small bisected peak. When a third row of particles is added, the surface takes a shape that is somewhere between the shapes it made with a single row of particles and two rows of particles. After deformation the PESC with three rows of particles has a flatter surface than that of the PESC with a single row of particles, but not as flat as the surface of the PESC with two rows of particles. When a fourth row of particles is added, the surface looks very similar to the surface seen for the PESC with three rows of particles.

The last column of FIG. 11 shows the strain contours in the matrix at 20% global strain. In the case where there is a single row of particles, the shear strain is highest at the surface where the pinning region exists. When a second row of particles is added, the highest shear strain is concentrated in bands along the inter-particle ligaments. The magnitude of the shear strain also increases when a second row of particles is added. When a third row of particles is added, the highest shear strain is still concentrated in the inter-particle ligaments. The magnitude of the shear strain also increases when a third row of particles is added. When more rows of particles are added beyond the third row, the highest shear strain remains concentrated in the inter-particle ligaments, however the magnitude of the shear strain does not increase by much.

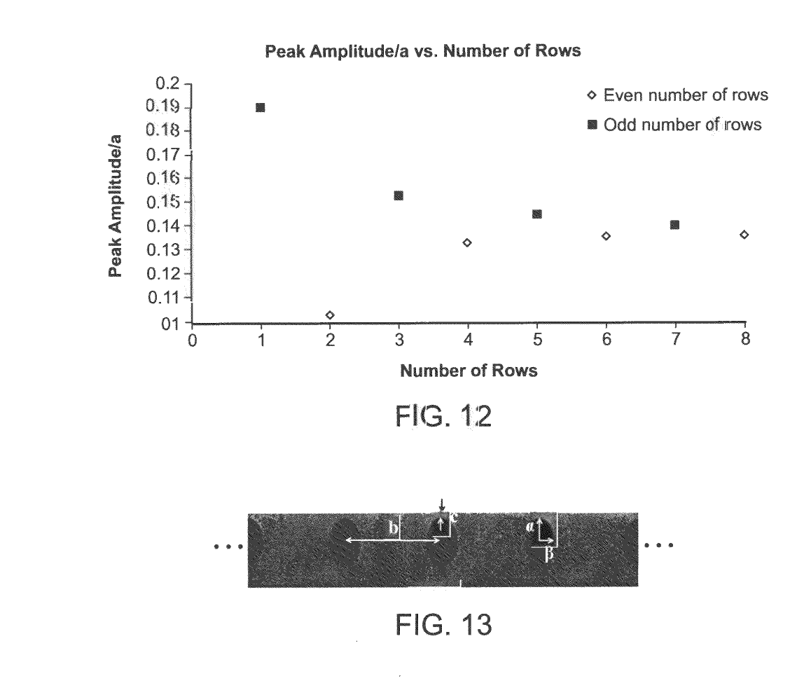

To quantify the effect of the number of rows of particles, we looked at the peak amplitude of the surface. The peak amplitude is again defined as the vertical distance between the highest and lowest points on the surface. FIG. 12 shows the effect of the number of rows of particles on the peak amplitude of the surface. Looking at the images in FIG. 11, it is no surprise that the PESCs with one row of particles have the highest peak amplitude. We saw in FIG. 11 that when a second row of particles was added the surface dramatically flattened out. That flattening of the surface causes the peak amplitude to drop dramatically, as seen in FIG. 12. Each successive odd row of particles that is added causes an increase in peak amplitude and every even row that is added causes a decrease in peak amplitude. However, every time a new row is added it causes the peak amplitude to change by less than the previous row did. As the number of rows grows, the normalized peak amplitude seems to approach a stable value. This is because each successive row that is added is further from the surface, and will therefore have less of an effect on the topography.

To investigate the effect of the aspect ratio, α/β, of the particles on the surface topography, we looked at PESCs made up of an array with a single row of particles. Since the particles are no longer part of a hexagonal array, not all of the dimensions shown in FIG. 6 still apply. The dimensions used in this section are shown in FIG. 13. To investigate the effect of the aspect ratio, other dimensionless parameters were held constant. We set the dimensionless parameter c/b, i.e. the ratio of the distance between the particles and the surface to particle spacing, to 0.058. The parameter

$$\text{?}$$

$$\text{?} \text{indicates text missing or illegible when filed}$$

was set to 0.27. The numerator of this parameter was held constant meaning that the area of the particles was unchanged. In the denominator we held constant both the distance from the particles to the surface (c) and particle spacing (b).

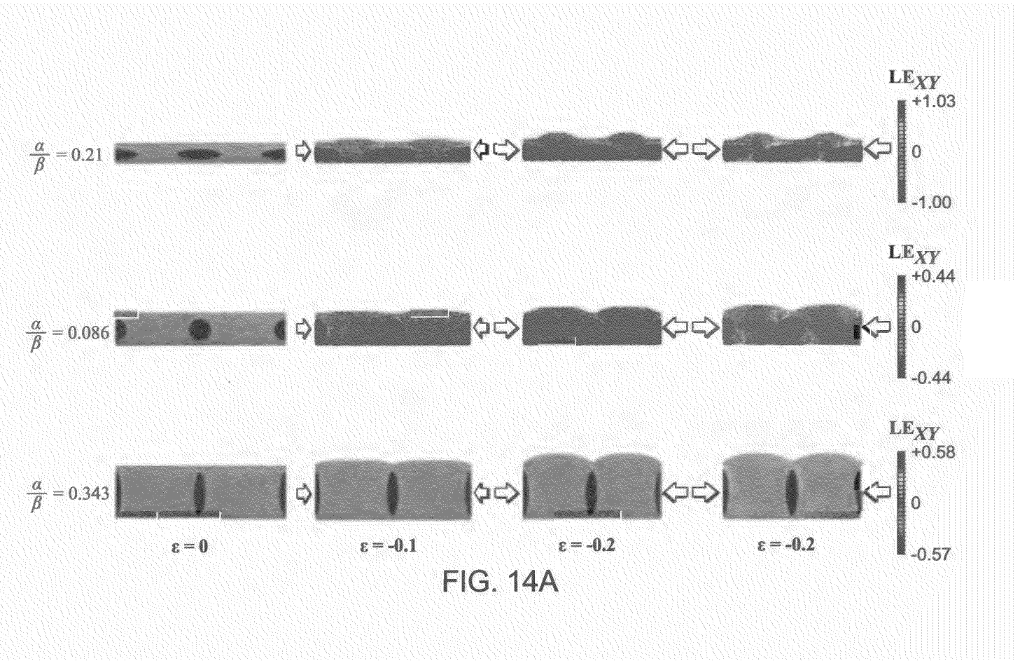

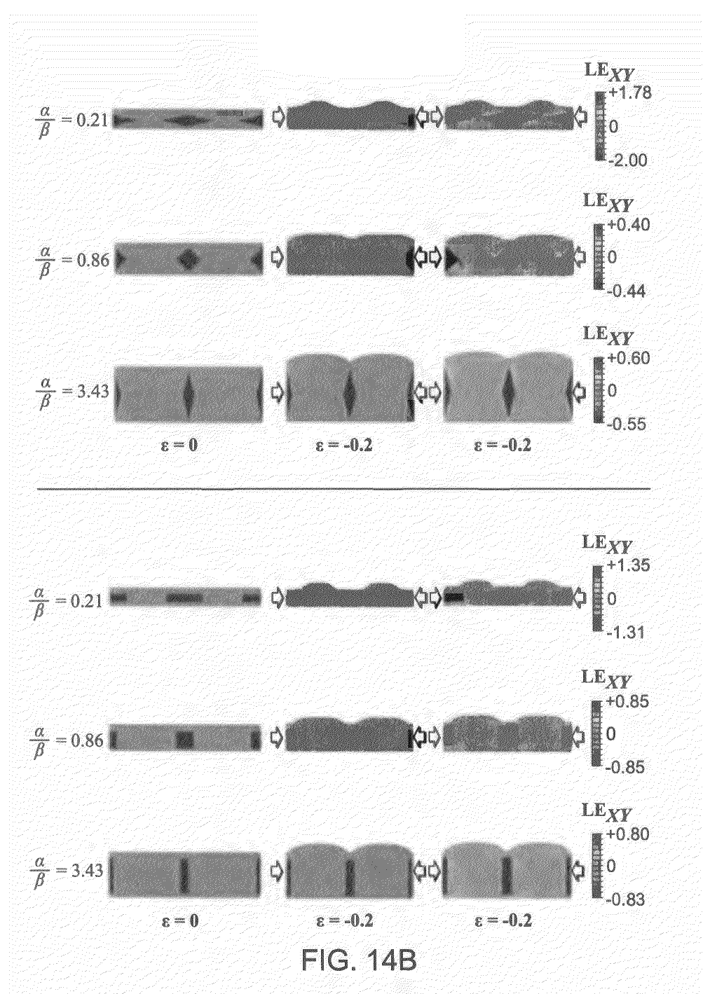

FIG. 14a shows several different simulations in which the aspect ratio of the particles were varied. It is clear from the figure that changing the aspect ratio of the particles dramatically changes the surface topography. For the higher values of α/β (the narrower particles) the pinning regions form sharp valleys while the area between pinning regions form a wide single peak. The pinning regions of the PESCs with lower values of α/β (the wider particles) form much wider valleys with narrower peaks in between. This implies that the larger the projected area of the particles onto the surface, the larger the pining region will be. This is true because the particles constrain the deformation of the surface near them, and thus a larger the projected area on the surface leads to the particle constraining the deformation of a larger area.

FIG. 14b shows simulations in which the particles were changed from the usual ellipsoidal shape to either diamonds or rectangles. In these simulations the aspect ratio of the particles were varied in the same way as in the simulations of ellipsoidal particles, and the same constant values were used for dimensionless parameters. In the case of both the diamond and the rectangular particles, fillets were added to the corners because without them the simulations were not able to converge to a solution. As was true for the ellipsoidal particles, the larger the projected area of the particles the larger the pinning region. One notable difference is that for the diamond-shaped particles at smaller values of α/β, the particles deform by bending at the tips, where the particle is thinnest.

The last columns in FIGS. 14a and 14b show shear strain contours in the matrix. For all shapes of particles the magnitude of the shear strain is the largest for the case with the widest particles. For the cases with the widest particles, the shear strain is concentrated primarily on the surface of the particles near the sides. When the particles are narrower (for both

$$\frac{α}{β} = 0.86$$

and 3.43) the magnitude of the shear strain is much smaller than for the widest particles. We believe that this is because the wider particles have less space between them, and thus interact with one another more, causing higher magnitudes of shear strain.

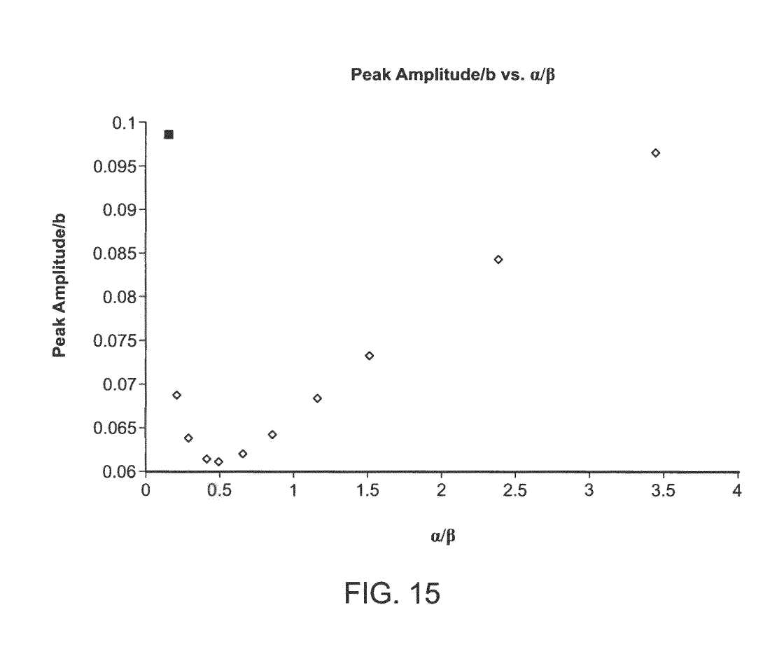

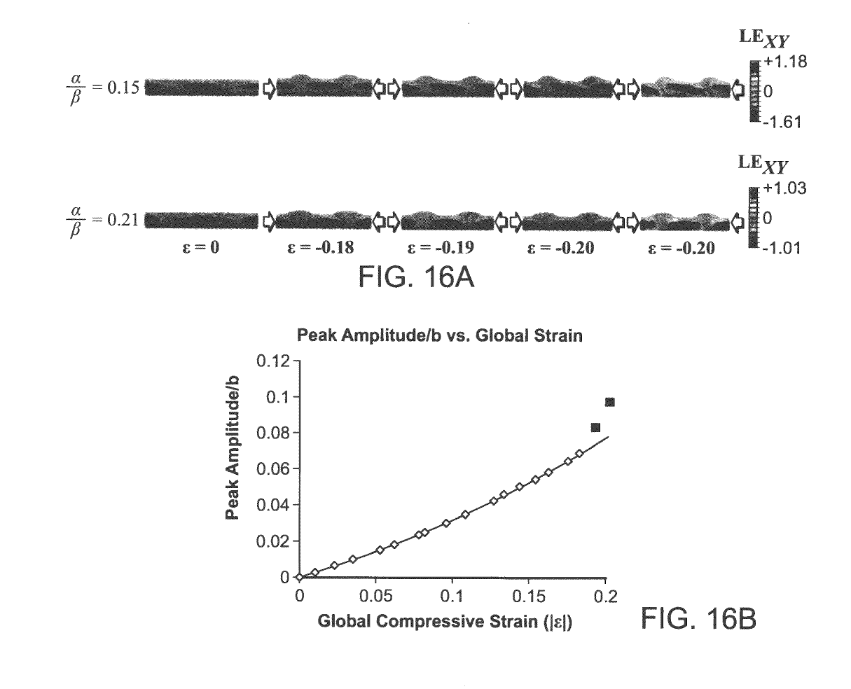

To quantify the effect of the aspect ratio on the surface topography, we again examined the peak amplitudes. FIG. 15 is a plot of the peak amplitude normalized by the particle spacing against the aspect ratio of the particles. All of the data points in the figure are based on PESCs made up of ellipsoidal particles. The PESCs were all compressed to 20% global strain. The figure shows that the narrower particles (highest value of α/β) induce a larger peak amplitude. As the particles become wider the normalized peak amplitude appears to decay nearly linearly until α/β reaches a value of 0.5. Below that the value of α/β, the normalized peak amplitude climbs as the particles become wider. The blue point on the curve corresponds to the simulation in which the particles had an aspect ratio of 0.15. The sudden large jump in peak amplitude from an aspect ratio of 0.21 to 0.15 can be explained by looking at FIG. 16.

FIG. 16a shows the results of the simulation for PESCs with particles of two different aspect ratios. For global compressive strains up to 18%, the results of the simulations for both aspect ratios show that the deformation in the matrix is symmetric. However, somewhere between 18% and 19% global strain the particles with the smaller aspect ratio rotate in the matrix, while the particles with a higher aspect ratio do not rotate. The rotation causes the particles to pull the surface down near the right side of each particle and push the surface up near the left side of each particle. This pushing up and pulling down causes a larger peak amplitude to form, which explains the large jump in normalized peak amplitude seen in FIG. 15. Looking at the shear strain contours, we again see that for the wider particles the magnitude of the shear strain is larger.

This effect can be seen in FIG. 16b, where the normalized peak amplitude is plotted against the global compressive strain for an aspect ratio of 0.15. The blue points correspond to all the strains before the particles rotate and the red points correspond to the strains after the particles rotate. In the figure the black line is a quadratic fit to the blue points with an R² value of 0.9999. It is clear from the figure that the rotation of the particles causes the normalized peak amplitude to increase more than it would have if the particles simply moved closer to one another without rotating.

While 16a helps to explain why there is a large jump in normalized peak amplitude for the smallest aspect ratio, it also reveals several important details about that particular simulation. First, the rotation of the wider particles indicates an instability in the system that was not seen for higher values of α/β. This instability causes the surface to suddenly change from a symmetric shape to a non-symmetric shape. This means that even with an initially symmetric arrangement of particles, it is possible to create surface topographies that are not symmetric. Also the fact that the instability did not occur until a certain amount of strain was reached means that with certain arrangements of particles it is possible to create both symmetric and non-symmetric surface topographies. While this instability was only seen for the smallest aspect ratio, we conjecture that a similar instability may occur for other aspect ratios if the PESCs were compressed to more than 20% global strain.

To this point, we have only investigated uniform arrays in which all of the particles are identical. Now we investigate non-uniform arrays of particles in which there can be a mixture of particles with different sizes and shaped.

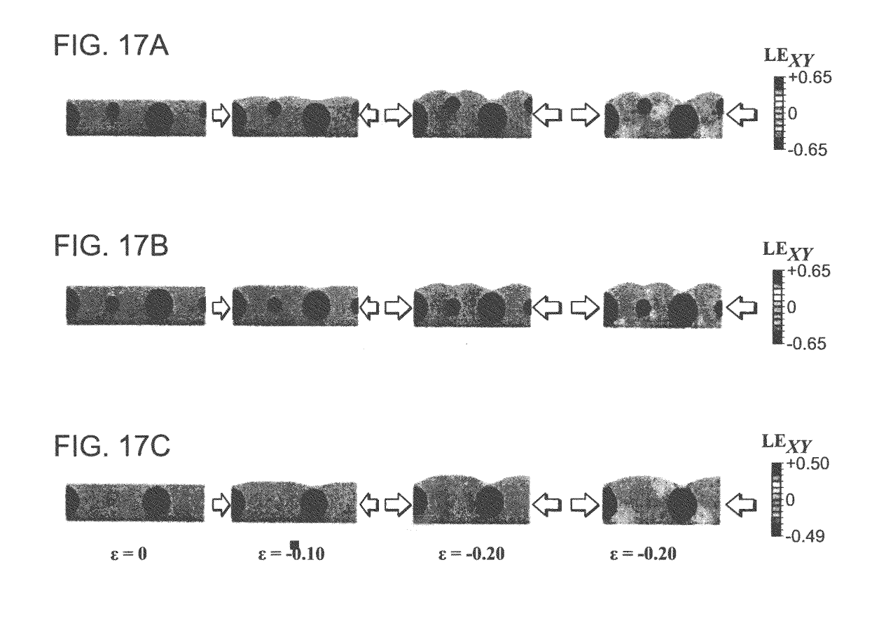

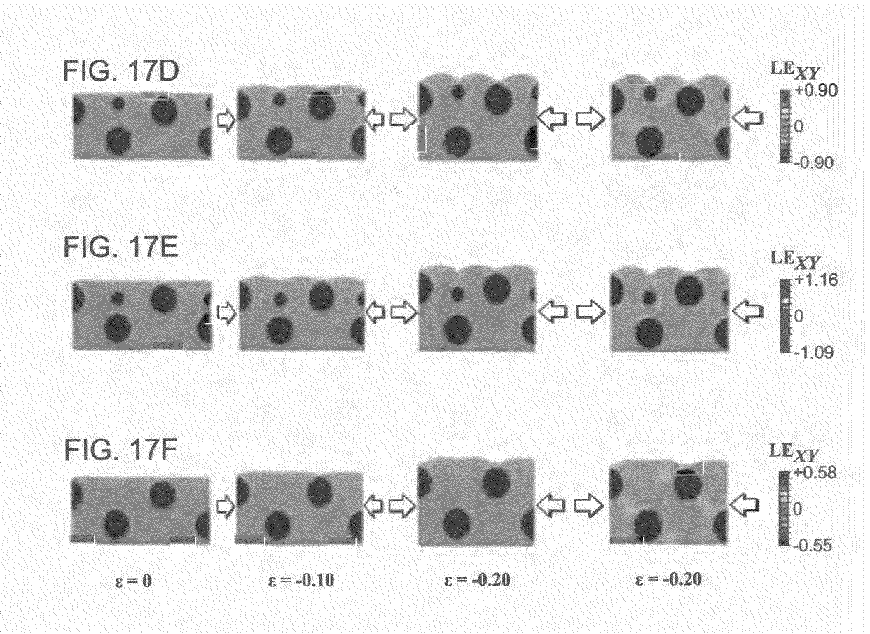

We look first at a mixture of circular particles of different sizes. In these arrangements the smaller particles are embedded in the matrix between the larger particles that would make up a uniform array. FIG. 17 shows the results of several simulations of the non-uniform arrays along with the original uniform arrays.

FIG. 17 shows several simulations of both uniform and non-uniform arrays of particles. FIGS. 17a and b are both made up of smaller particles that are embedded into the matrix between larger particles that are arranged as the uniform array shown in FIG. 17c. Similarly, FIGS. 17d and e are both made up of smaller particles that are embedded into the matrix between larger particles that are arranged as the uniform array shown in FIG. 17f. For both FIGS. 17c and f, the uniform array is defined with constant values of the dimensionless parameters: a/c=20, a/α=4 and α/β=1. In those parameters the dimensions a,c, and α are defined as described in FIG. 6. For all of the non-uniform arrays shown in the figure we set the parameter α/r, where r is the radius of the smaller particles, to 2.

In FIG. 17a, the smaller particles are aligned such that the distance between the smaller particles and the surface (c as defined in FIG. 6) is the same as those for the larger particles and the surface. In FIG. 17b the smaller particles were aligned such that the centers of both the smaller and larger particles lay on the same horizontal plane. As shown in FIG. 17c, with the uniform array of a single row of particles a single large peak forms on the surface at a location directly between the particles. When smaller particles are added a bisected peak appears aligned directly above the smaller particles where the single large peak was seen for the uniform array. For the case in FIG. 17a, the valley aligned above the smaller particles has a larger radius of curvature than that of the valley seen at the same location in FIG. 17b. This is because when the smaller particles are closer to the surface those particles more easily constrain the deformation of the matrix causing the pinning region to be larger. The larger pinning region leads to a wider valley, i.e., the radius of curvature is larger.

FIGS. 17d, e and f show the results of simulations nearly identical to FIGS. 17a, b and c, but with two rows of larger particles instead of a single row. In the case of FIG. 17f, the PESC forms a bisected peak without the addition of the smaller particles. This is because the second row of particles is pinning the surface. When the smaller particles are added to the array, the bisected peak becomes much more pronounced. As we saw for the single row of particles, the valley located above the smaller particles has a larger radius of curvature for the case where the distance c is constant than for the case where the central horizontal axis of the smaller particles is aligned with the central horizontal axis of the larger particles. This can be explained with the same reasoning used for the single row of particles.

Looking closely at FIG. 17e, we see that as the PESC is compressed the smaller particles move down relative to the larger particles in the first row. This movement is not seen in FIG. 17b where there is a single row of particles. For the case with two rows of larger particles, the smaller particles move down because they are being pulled down by the larger particles below them. The combined effects of both the smaller particles and the larger particles in the second row cause the surface to be pulled down further in the region where the bisected peak appears. This in turn causes the bisected peak to appear sharper than the case shown in FIG. 17d.

The last column of FIG. 17 shows the shear strain in the matrix for each case. Looking at the contours we see that for both one and two rows of particles, the magnitude of the shear strain is larger for the case where the smaller particles are in the matrix. It should also be noted that for two rows of particles, when there are no small particles the shear strain forms bands between the particles. However, when the smaller particles are added there is a concentration of high magnitude shear strain located on the bottom surface of the small particles and the shear bands are not as prominent.

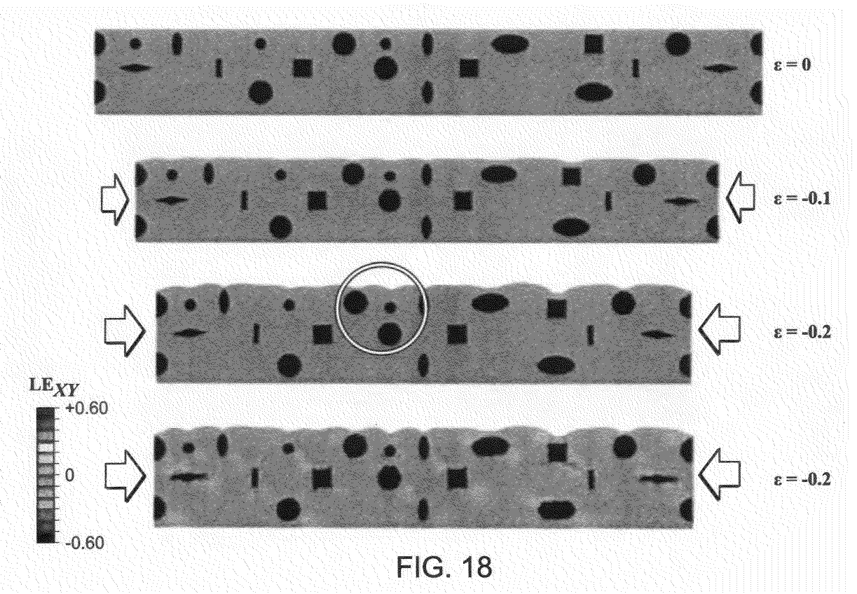

Another non-uniform array of particles is shown in FIG. 18. The PESC shown in this figure have a mixture of particles with different sizes, shapes, and orientations. Looking at the deformed surface of the PESC it is clear that a variety of different topographical features are formed in a single PESC. The shape of each topographical feature is controlled primarily by the particles in the immediate vicinity of the feature. For example, looking at the region shown in the circle, the surface forms a shape similar to that seen in FIG. 17e. This is because in the region near that topographical feature the particle distribution is similar to that seen in FIG. 17e. Looking at the shear strain contours, we see a similar shear strain distribution in the region associated with that surface feature. Also in the shear strain contours we see bands of shear strain forming in the regions where the particles form a staggered array. Similar regions of shear bands were seen in previous cases with a staggered array of particles. The fact that the shape of topographical features is controlled primarily by the particles near the feature is important because it means that this method of creating tunable surfaces allows for highly localized control of the surface topography, which is difficult to do through other methods such as wrinkling.

As discussed earlier, the material used by the 3D printer to create the matrix was relatively incompressible compared to the amount it could be sheared. In this section we focus on investigating the effects of a more compressible matrix. Table 2 shows the pertinent material properties of the two materials used for the matrix. The material that was based on the 3D printed samples will be referred to as relatively incompressible, while the other material will be referred to as compressible. For the relatively incompressible material, the bulk modulus was about 500 times larger than the shear modulus, whereas for the compressible material the bulk and shear moduli were of the same order of magnitude.

TABLE 2
Material properties of the matrix with different compressibility

| | G (MPa) | K (MPa) | K/G | N |
|---|---|---|---|---|
| Relatively Incompressible | 0.33 | 166.7 | 505.2 | 0.499 |
| Compressible | 0.4 | 0.66 | 1.65 | 0.250 |

We now examine the effect of the compressibility for two different particle arrays with different relative inter-particle ligament lengths,

$$( \frac{a - 2 β}{a} ) .$$

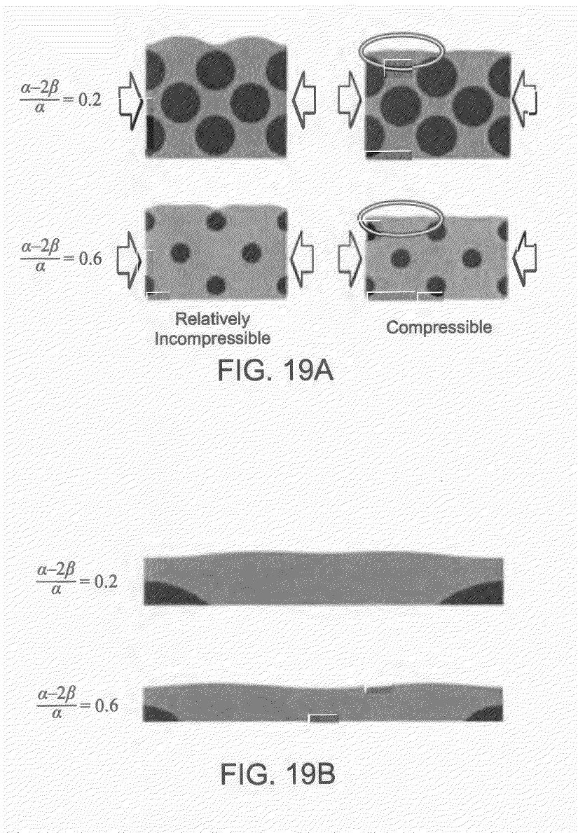

FIG. 19 shows the results of the simulation for the four combinations of relative inter-particle ligament length and material models. Notice that the relatively incompressible matrix lead to larger changes in surface topography. Note also that changing the compressibility of the matrix affects the two different relative inter-particle ligament lengths differently.

For the larger ligaments, the surface topography for both the relatively incompressible and compressible matrices form a similar shape in which the there is a local minimum aligned directly above each particle. For the smaller ligaments, the surface topographies are different in morphology as well as magnitude. Looking at FIG. 19b we can see that for compressible matrix with the smaller ligaments a bisected peak forms.

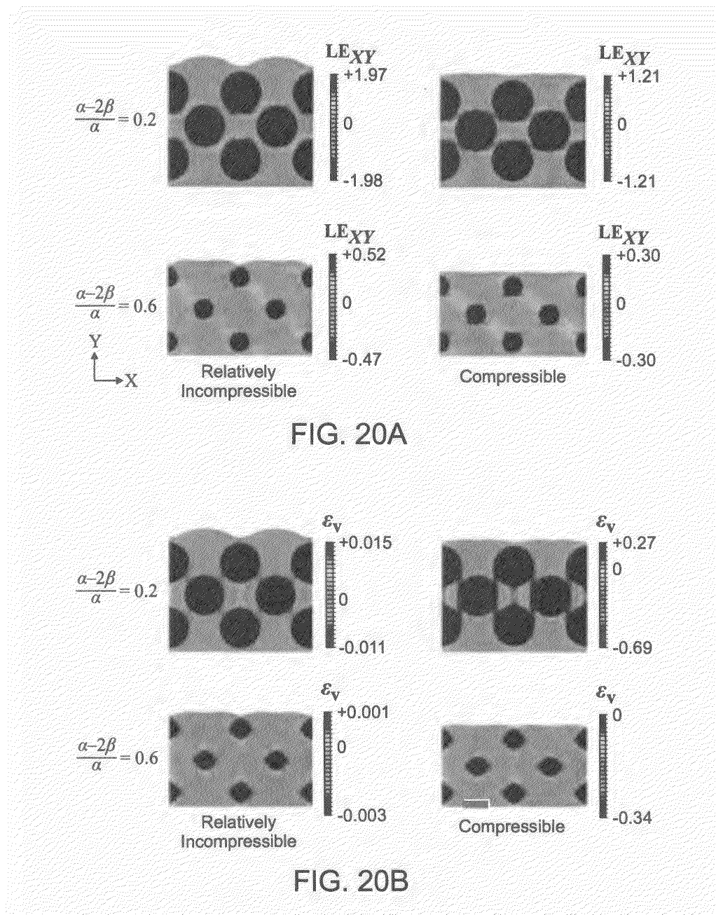

FIG. 20 sheds light on why changing the compressibility of the matrix affects the surface topography of the PESCs with smaller ligament lengths more than the PESCs with larger ligament lengths.

FIG. 20a shows the strain along the X′-axis in the relatively incompressible case for the two different relative inter-particle ligament lengths. As it was pointed out above, the shear strain for both inter-particle ligament lengths is concentrated primarily in the inter-particle ligaments. It should be noted however, that the magnitude of the shear strain is much larger for the PESC with the smaller inter-particle ligaments. Since in both of those models the matrix was relatively incompressible the global compressive strain was accommodated almost exclusively by local shear strain rather than by volumetric stain.

FIG. 20b shows the volumetric strain in the matrix for both the relatively incompressible and compressible cases with both relative inter-particle ligament lengths. The relatively incompressible matrix case shows negligible volumetric strain. Looking at the scale bars, we see that for the compressible cases the magnitude of the volumetric strain is more than an order of magnitude larger than for the relatively incompressible cases and is of similar magnitude to the shear strain of the incompressible case. This is because in the relatively incompressible case the material has a strong preference to change shape rather than volume. However in the compressible case, where the bulk and shear moduli are on the same order of magnitude, the matrix material does not have a strong preference for shape change or volume change.

In general, the matrix will deform in the most energetically efficient way to accommodate the global compressive strain. In the relatively incompressible case this means that the matrix undergoes shear strain with very little volumetric strain. This leads to a higher magnitude of localized shear strain, as seen in the case with the smaller inter-particle ligaments. In the compressible case, it is more energetically efficient for the matrix to volumetrically strain than to accommodate the global compressive strain through high magnitudes of local shear strain. In the relatively incompressible case with the larger inter-particle ligaments, the shear strain was not nearly as large as the shear strain for the smaller inter-particle ligaments. Therefore, when the matrix was changed to the compressible material the difference in the surface topography was not as large for the PESC with the larger inter-particle ligaments.

In all of the simulations shown so far, the material model for the particles has been based on the stiffest material available from the 3D printer. The material available in the 3D printer used for the particles has a Young's modulus of approximately 1500 MPa while the material used for the matrix has a Young's modulus of approximately 1 MPs. In this section we investigate how changing the stiffness of the particles can change the surface topography.

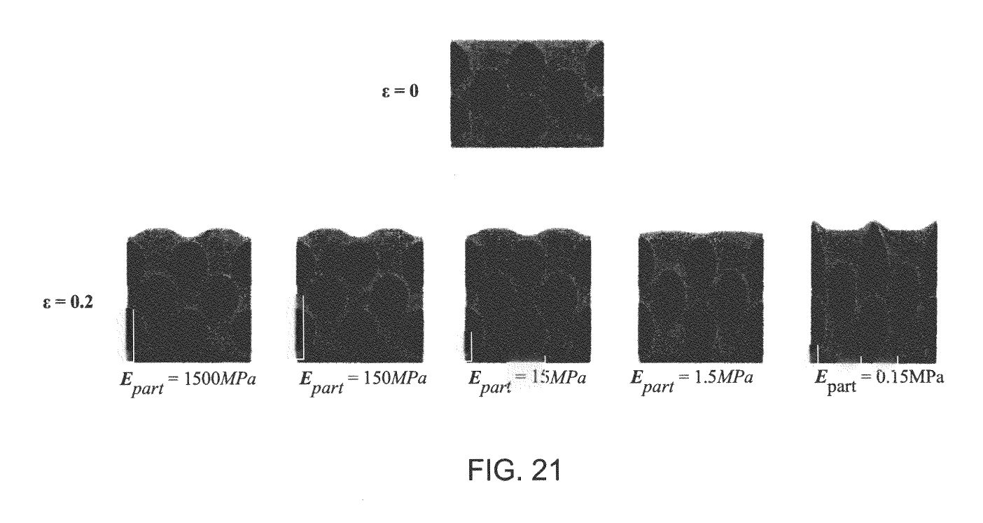

FIG. 21 shows the results of simulations in which we varied the Young's modulus of the particles over several orders of magnitude.

The stiffest particles are representative of the materials available from the 3D printer. Looking at the figure it is clear that reducing the stiffness of the particles from the stiffest by a single order of magnitude has very little effect on the results of the simulation. However, when the particle stiffness is reduced by another order of magnitude, to 15 MPa, the particles start to deform when we apply the compressive load. The deformation of the particles causes a slight variation in the surface topography. when the stiffness is reduced by yet another order of magnitude, to 1.5 MPa, the particles deform a large amount and cause the surface to change shape dramatically. As the particle stiffness approaches the stiffness of the matrix the surface becomes much flatter. This makes sense because if the particles and the matrix have the same material properties, the addition of particles is irrelevant.

The rightmost image corresponds to particles with a Young's modulus of 0.15 MPa, i.e., the particles are softer than the matrix. This causes a dramatic change in the surface topography. It appears that when the particles are softer than the matrix, and therefore deform more than the matrix, the particles no longer pin the matrix down. Instead, of being a local minimum the surface above the particles is a local maximum.

While the work done so far has primarily investigated PESCs with particles stiff enough to be considered nearly rigid, the ability to have the particles deform presents new opportunities for creating novel surface topographies that should be studied going forward. This also suggests the potential to use materials that will plastically deform at low yield stress thus creating a permanently deformed topography.

The prototype PESCs used in the experiments were made with an Object500 Connex Multi-Material 3D printer. This printer is capable of printing multiple materials in a single part with good bonding between the different materials. The materials available as outputs from the printer are all proprietary materials. For our PESCs, the matrix was made out of the TangoPlus material, which the company describes as a “rubber-like material.” The material used for the particles in the PESCs was the VeroBlack material, which the company describes as a “rigid opaque material.” While the VeroBlack is not completely rigid, it is significantly stiffer than the matrix. The Young's moduli for the TangoPlus and VeroBlack were measured using compressive and tensile tests by other members of the Boyce Group and found to be approximately 1 MPa and 1500 MPa respectively.

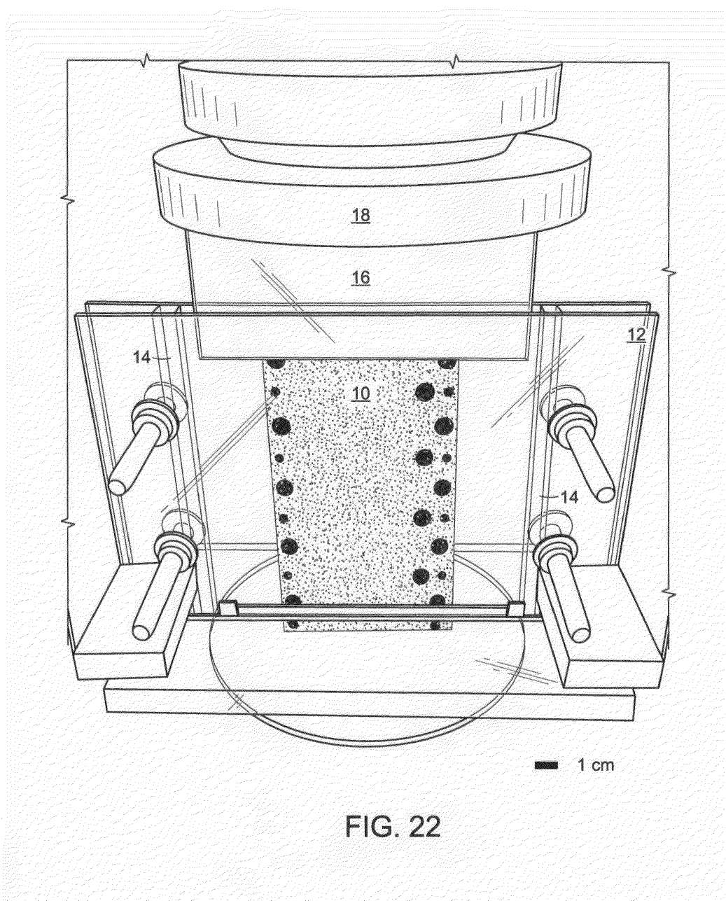

A typical image of the experimental setup is shown in FIG. 22. Since the simulations were all run with plane strain elements, it was important that the experiments be performed under plane strain conditions. Te enforce the plane strain condition, the 3D printed sample 10 was sandwiched between two clear acrylic plates 12. The plates 12 were secured together using four bolts that went through both plates. The holes for the bolts, as well as the plates themselves were cut using a laser cutter. We chose acrylic as the material for the plates because it is transparent and thus allowed us to use a camera to get clear images of the sample throughout the experiments. Two pieces of acrylic 14 were also cut to the thickness of the 3D printed samples and were used as spacers between the two plates to ensure that the plates were secured the same distance apart in each experiment. Another piece of acrylic 16 was cut to go on top of the sample, between the two plates and extend above the plates. This piece was used to transfer the compressive load from the cross head of the Zwick mechanical tester 18 to the sample. All of the contacting surfaces between the sample and the acrylic were lubricated using mineral oil.

The experiments were all performed using a Zwick mechanical tester with which a compressive load was applied using the displacement control feature of the machine. All of the samples were compressed to 20% global strain. Since the TangoPlus material used in the matrix of the samples is highly viscoelastic, the tests were performed at very low strain rates (approximately 10⁻⁴/second) to reduce any time dependent effects the samples may have introduced. During the tests a high resolution camera was setup on a tripod in front of the sample, and set to take a picture every half second. The camera was a Point Grey CMLN-13S2M camera with a Nikon AF Micro-Nikkor 60 mm f/2.8D lens.

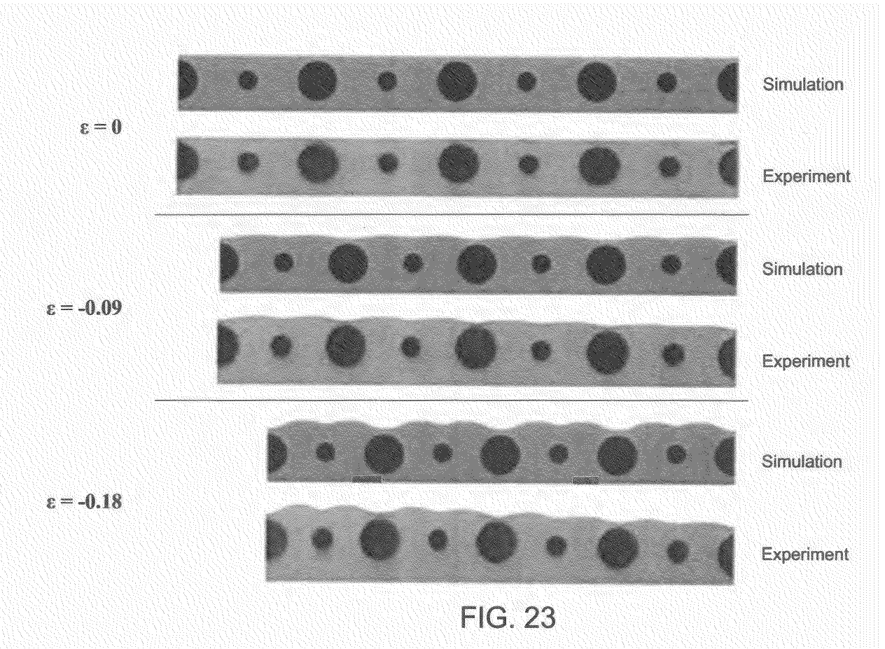

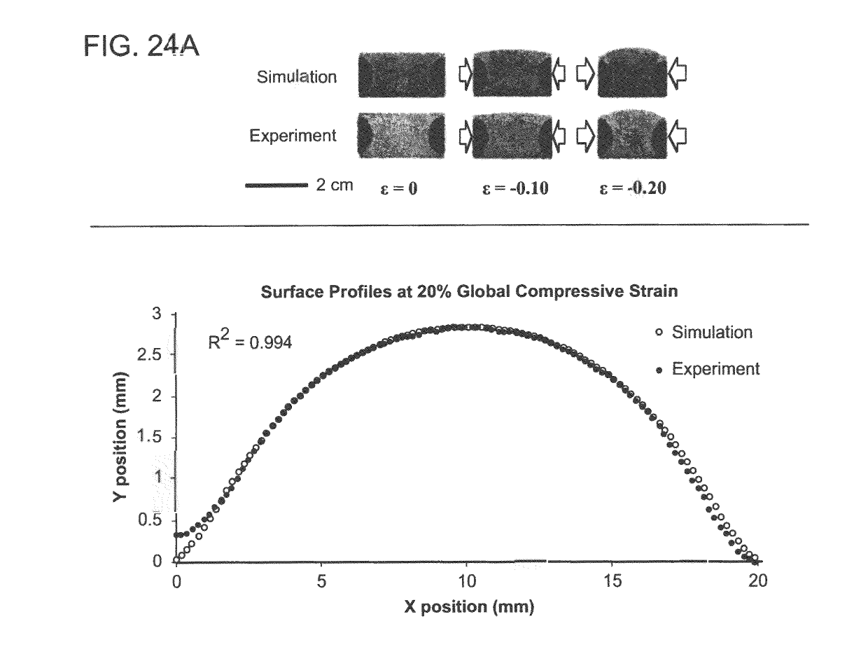

The geometries selected to be validated were some of the PESCs used in the investigation of the effect of the number of rows of particles as well as some of the non-uniform arrays of particles. FIG. 23 shows simulation and experimental results of the full RVE of a non-uniform array of particles at various global compressive strains.

As the figure shows, the simulated RVE's exhibit a periodicity not seen in the experiments. We believe that the lack of periodicity in the experiments is attributable to friction in the system. Friction played no role in the simulation. However, the introduction of the plates, which were needed to enforce the plane strain condition in the physical experiments, introduced friction into the system. The introduction of the mineral oil helped, but did not eliminate the friction. The friction appears to be more significant at the right edge (which was the bottom surface of the test machine). Although we attempted to reduce the friction, we were not successful.

The left sides of the images in the figure correspond to the top of the samples in the experiments, i.e., the part of the sample closest to the region where the compressive force is applied. If we look only at the left most unit cell there is good qualitative agreement between with the simulations and the experiments. For the rest of this section will focus on the experimental unit cells closest to the compressor head.

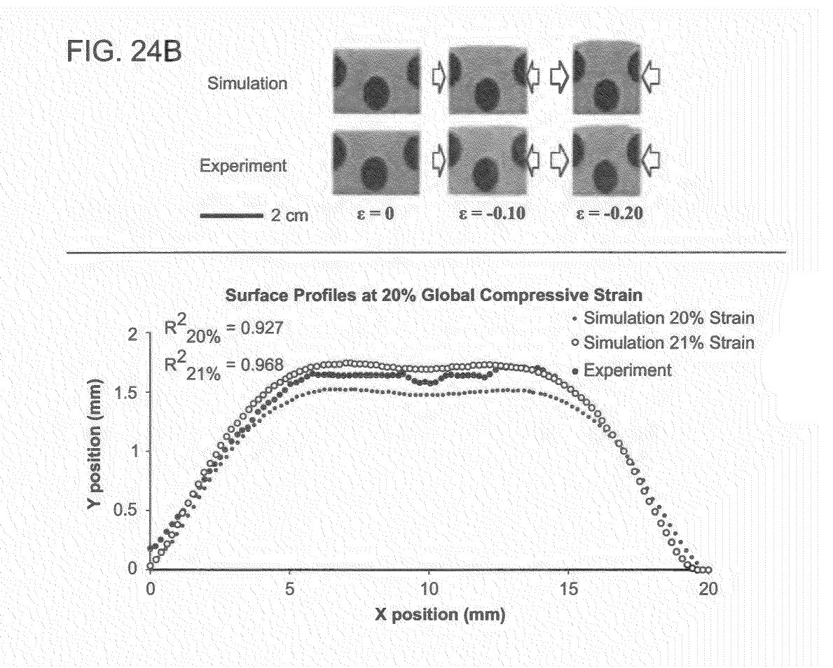

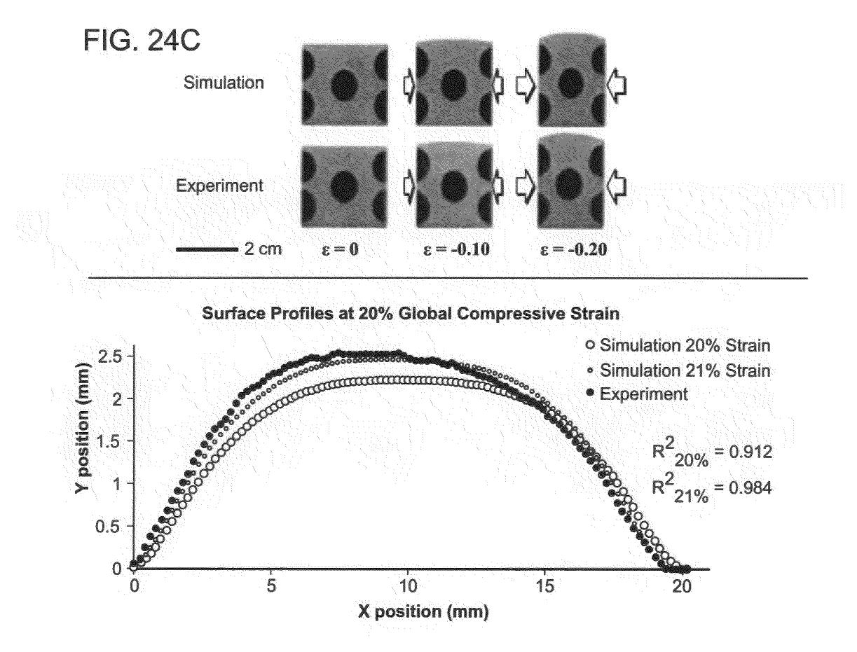

FIG. 24 shows simulation and experimental results for tests that were part of the investigation of the effect of the number of rows of particles on the surface topography. On the whole, we see good qualitative agreement between the simulations and experiments. Looking at the case with a single row of particles in FIG. 24a, a single large peak appears aligned between the two particles for the simulation and the physical experiment. For the case with two rows of particles, shown in FIG. 24b, a bisected peak appears aligned above the particles in the second row for both the simulations and physical experiments. With three rows of particles (FIG. 24c), the surface for both sets of experiments takes on a shape that is flatter than the case with a single row of particles, but does not have the bisected peak seen for the PESC with two rows of particles.

The graphs in FIGS. 24a, b and c show the surface profiles of both the simulations and experiments at 20% global compressive strain. The X-Y coordinates of the surface of the experiments were extracted by first tracing the surface in Photoshop to remove the background. After the background was removed, we used custom Matlab code to extract the surface coordinates in pixels. To get the experimental surface coordinates in mm, we found dimensions of a single particle in pixels and, since we knew the dimensions in mm, we were able to convert the units of the surface profile into mm. Once we had the surface profile of the experimental surfaces, we were able to compare them to the surface profiles found in the simulations. We compared the two profiles by calculating the coefficient of determination (R²) defined by Equation 4.

$${R}^{2} = 1 - \frac{{{Σ}_{i} ( {y}_{i} - {p}_{i} )}^{2}}{{{Σ}_{i} ( {y}_{i} - μ )}^{2}} \qquad ( 4 )$$

The R² values are shown on each plot. The plots in FIG. 24b and c show the curves of the simulations at both 20% and 21% global compressive strain. The R² values which compare the experiments to both simulation curves are shown. We found that for those cases experimental profiles fit eh simulation profiles at 21% global compressive strain better than the simulation profiles at 20% strain. We believe that this is because the friction in the experiments may cause local strains in near the compressor head to be higher than 20% and the local strains far away from the compressor head to be lower than 20%, while still combining to 20% global compressive strain. The best R² value for all of the cases in FIG. 24 are above 0.96, indicating that the experimental and simulation surface profiles are similar to one another.

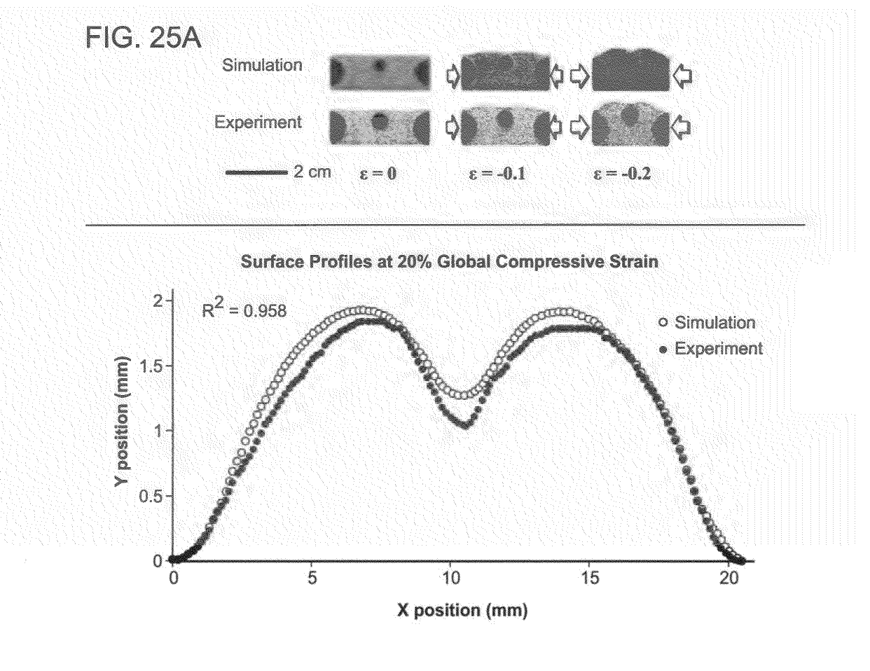

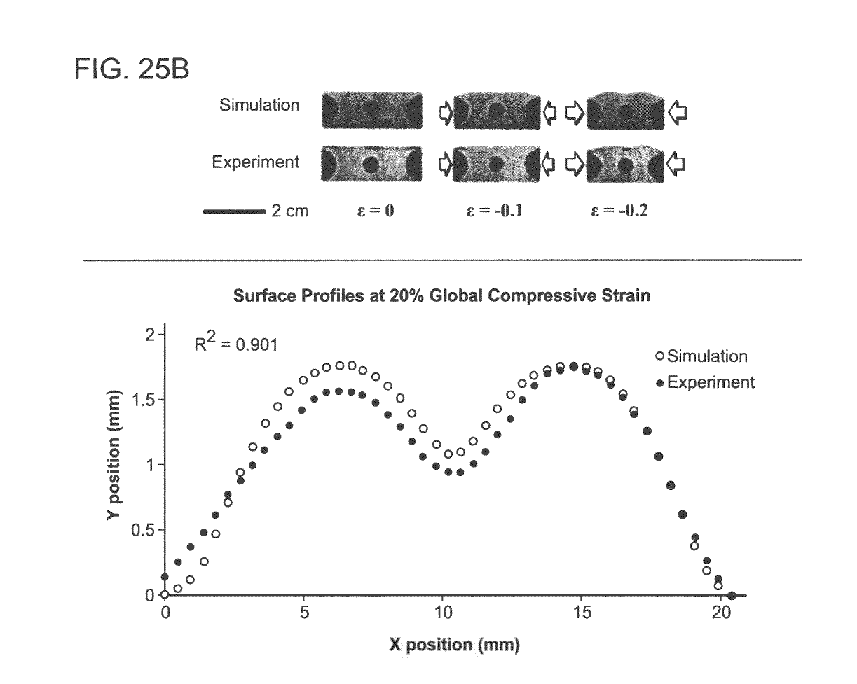

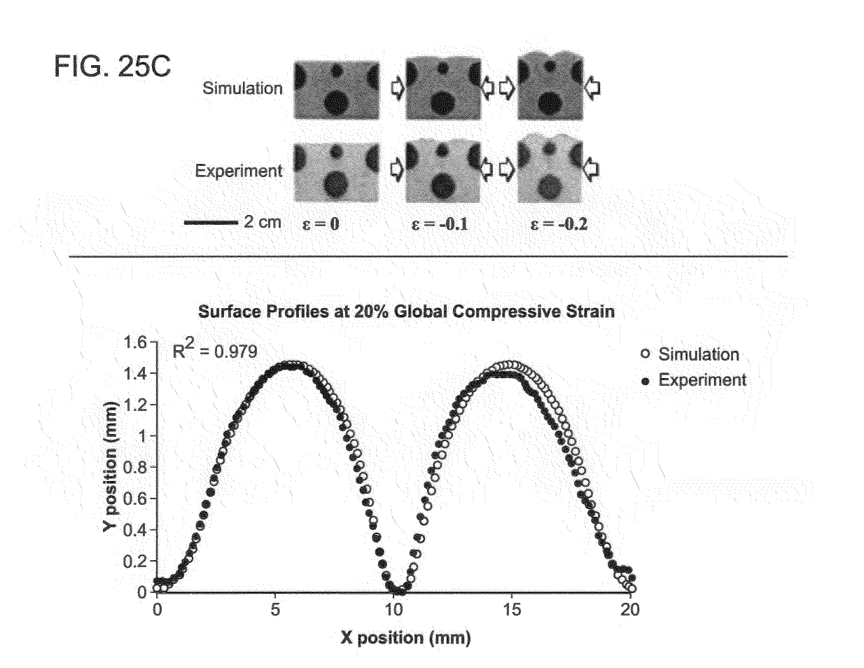

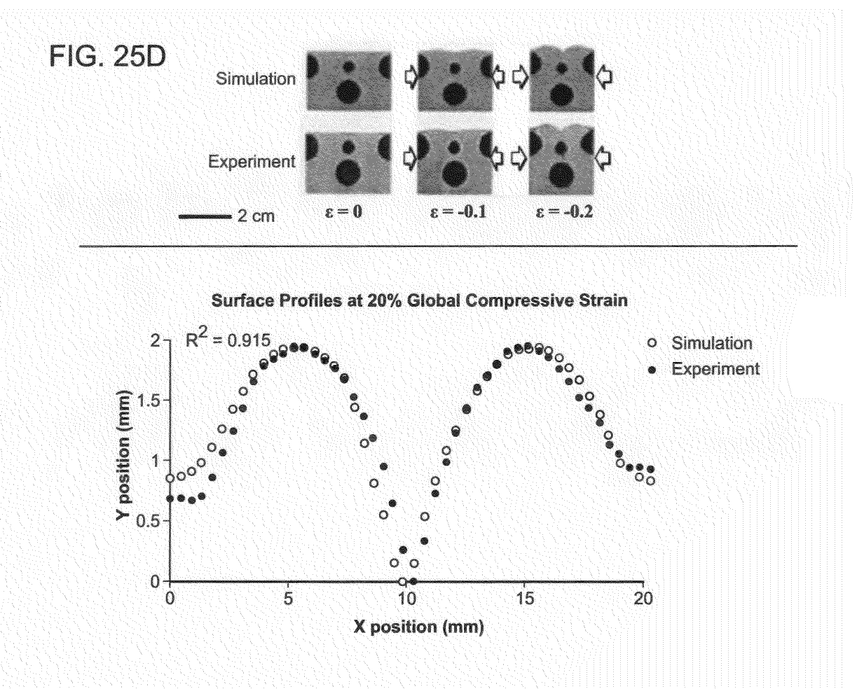

We show the results of the simulations and physical experiments of the non-uniform arrays of particles in FIG. 25. For all cases, we again see reasonably good qualitative agreement between the simulations and experiments. FIG. 25a shows the case in which the smaller particles and the larger particles are the same distance from the surface. As we saw in the simulations, the experiments show the smaller particles moving up relative to the larger particles, which causes higher peak amplitude. FIG. 25b shows the case in which the horizontal axes of the smaller and larger particles are aligned. We see that upon compression the particles stay aligned with one another. FIG. 25c and d depict experiments with two rows of particles. In both the simulations and the physical experiments, the local minimum aligned above the smaller particles has a larger radius of curvature when the smaller and larger particles were the same distance from the surface than the case where the horizontal axes were aligned. The same method that was used to create the plots shown in FIG. 24 was used to create the plots shown in FIG. 25. We see that for each case (with the exception of FIG. 25b and d) the R² values are all above 0.95 indicating a very good fit. Even for the case shown in FIG. 25b and d the R² values of 0.901 and 0.915 indicate a moderately good fit, and the major patterns that were seen in the simulations also appeared in the experiments. These results indicate that our simulations are capturing the important aspects of the behavior of the PESCs.

The potential applications for controlling surface topography through the use of PESCs are numerous and are relevant in a number of different fields. One possible application relates to the visual appearance of the surfaces. PESCs could also be used to create surfaces with tunable wettability. Through the application of a load, the surface could change from wetting to non-wetting and back again. The ability to change a surface to non-wetting could be used to reduce biofouling.

Since the shape of contacting surfaces affects friction and adhesion, PESCs could be used to control the amount of friction between two surfaces. The ability to change surface topography could also be used to study the way cells move through changing environments. This could be useful, for example, in understanding cellular flow through capillaries.

We intend to investigate the effect of surface topography on aerodynamic drag. The idea is to create PESCs that can tune the surface topography in order to dynamically minimize the drag at different Reynolds numbers. A potential application would be coating vehicles with “smart” surfaces so that when they are traveling at different speeds the surface would change to minimize the drag and thus increase fuel efficiency.

We have introduced a new class of particle-enhanced soft composites (PESC) that can generate, on demand, custom and reversible surface topographies, with surface features that can be highly localized. These features can be specifically patterned or alternatively can be random in nature. Our PESC samples comprise a soft elastomeric matrix with stiff particles embedded below the surface. The surfaces of the samples presented in this thesis are originally smooth and flat but complex morphologies emerge under application of a stimuli (here we show application of primarily compressive loading). We have demonstrated these adaptive surface topographies with both physical experiments and finite element simulations which are used to design and to study the mechanical response. A variety of different surface patterns were attained by tailoring different dimensionless geometric parameters (e.g. different particle sizes, shapes, and distributions), as well as material properties. The design space of the system and the resulting surface topographies have been explored and classified systematically. Given that our method depends primarily on the geometry of the particle arrays, our mechanism for on-demand custom surface patterning is applicable over a wide range of length scales. These surfaces can be used in a variety of different applications including control of fluid flow, adhesion, wettability and many others.

For more information see, “Tunable Surface Topography Through Particle-Enhanced Soft Composites” Master's Thesis, Department of Mechanical Engineering, Massachusetts Institute of Technology (2014). The contents of this thesis and the other referenced noted herein are incorporated herein by reference in its entirety.

It is recognized that modifications and variations of the present invention will occur to those of ordinary skill in the art and it is intended that all such modifications and variations be included within the scope of the appended claims.

### REFERENCES

Achenbach, Elmar. (1971), Influence of surface roughness on the cross-flow around a circular cylinder. journal of Fluid Mechanics, 46(02), 321-335.

Allen, Howard G. (1969). Analysis and design of structural sandwich panels (Vol. 51): Pergamon press Oxford.

Allen, Justine J. Bell, George R R, Kuzirian, Alan M, & Hanlon, Roger T. (2013). cuttlefish skin papilla morphology suggests a muscular hydrostatic function for rapid changeability. Journal of morphology, 274(6), 645-656.

Allen, Justine J. Mäthger, Lydia M. Barbosa, Alexandra, & Hanlon, roger T. (2009). Cuttlefish use visual cues to control three-dimensional skin papillae for camouflage. Journal of Comparative Physiology A. 195(6), 547-555.

Bowden, Ned, Brittain, Scott, Evans, Anthony G., Hutchinson, John W., & Whitesides, George M. (1998). Spontaneous formation of ordered structures in this films of metals supported on an elastomeric polymer. Nature, 393(6681), 146-149.

Cabuz, C., Ohnstein, T. R., & Elgersma, M. R. (2001). Electrostatic/pneumatic actuators for active surface: Google Patents.

Cai, S., Breid, D., Crosby, A. J., Suo, Z., & Hutchinson, J. W. (2011). Periodic patterns and energy states of buckled films on compliant substrates. Journal of the Mechanics and Physics of Solids. 59(5), 1094-1114, doi: http://dx.doi.org/10.1016/j.jmps.2011.02.001

Cao, Guoxin, Chen, Xi, Li, Chaoroug, Ji, Ailing, & Cao, Zexian. (2008). Self-Assembled Triangular and Labyrinth Buckling Patterns of Thin Films on Spherical Substrates. Physical Review Letters, 100(3), 036102.

Cassie, A. B. D., & Baxter, S. (1944). Wettability of porous surfaces. Transactions of the Faraday Society, 40(0), 546-551. doi: 10.1039/TF9444000546

Crosby, Alfred J., Hageman, Mark, & Duncan, Andrew. (2005). Controlling Polymer Adhesion with “Pancakes”. Langmuir, 21(25), 11738-11743. doi: 10.1021/1a051721k

Danielsson, M., Parks, D. M., & Boyce, M. C. (2002). Three-dimensional micromechanical modeling of voided polymeric materials. Journal of the Mechanics and Physics of Solids, 50(2), 351-379. doi: http://dx.doi.org/10.1016/S0022-5096(01)00060-6

Genzer, Jan, & Groenewold, Jan. (2006). Soft matter with hard skin: From skin wrinkles to templating and material characterization. Soft Matter, 2(4), 310-323. doi: 10.1039/B516741H

Hanlon, Roger T, & Messenger, John B. (1988). Adaptive coloration in young cuttlefish (Sepia officinalis L.): the morphology and development of body patterns and their relation to behaviour. Philosophical Transactions of the Royal Society of London. Series B, Biological Sciences, 437-487.

Huang, Z. Y., Hong, W., Sao, Z. (2005). Nonlinear analyses of wrinkles in a film bonded to a compliant substrate. Journal of the Mechanics and Physics of Solids, 53(9), 2101-2118. doi: http://dx.doi.org/10.1016/j.jmps.2005.03.007

Kozlowski, Michael C. (2008). Mechanics of Periodic Elastomeric Structures with Varying Void Volume Fraction and Thin-Film Coating. (BS), MIT.

Lahann, Joerg, Mitragotri, Samir, Tran, Thanh-Nga, Kaido, Hiroki, Sundaram, Jagannathan, Choi, Insung S., Langer, Robert. (2003). A Reversibly Switching Surface. Science, 299(5605), 371-374. doi: 10.1126/science.1078933

Li, Bo, Cao, Yan-Ping, Feng, Xi-Qiao, & Gao, Huajian. (2012), Mechanics of morphological instabilities and surface wrinkling in soft materials: a review. Soft Matter, 8(21), 5728-5745.

Minko, Sergiy, Müller, Marcus, Michail, Nitschke, Mirko, Grundke, Karina, & Stamm, Manfred. (2003). Two-Level Structured Self-Adaptive Surfaces with Reversibly Tunable Properties. Journal of the American Chemical Society, 125(13), 3896-3900. doi: 10.1021/ja0279693

Sidorenko, Alexander, Krupenkin, Tom, Taylor, Ashley, Fraizl, Peter, & Aizenberg, Joanna. (2007). Reversible Switching of Hydrogel-Actuated Nanostructures into Complex Micropatterns. Science. 315(5811), 487-490. 10.1126/science.1135516

Terwagne, Denis, Brojan, Miha, & Reis, Pedro M. (2014). Smart Morphable Surfaces for Aerodynamic Drag Control. Advanced Materials, n/a-n/a. doi: 10.1002/adma.201401403

Yin, Jie, Cao, Zexian, Li, Chaorong, Sheinman, Izhak, & Chen. Xi. (2008). Stress-driven buckling patterns in spheroidal core/shell structures. Prodeedings of the National Academy of Sciences, 105(49), 19132-19135. doi: 10.1073/pnas.0810443105

Yin, J., Yague, J. J. L., Boyce, M. C., & Gleason, K. K. (2014). Biaxially Mechanical Tuning of 2-D Reversible and Irreversible Surface Topologies through Simultaneous and Sequential Wrinkling. Acs Applied Materials & Interfaces, 6(4), 2857-2864. doi: 10.1021/am4054207

Yin, Jie, Yagüe, Jose Luis, Eggenspieler, Damien, Gleason, Karen K., & Boyce, Mary C. (2012). Deterministic Order in Surface Micro-Topologies through Sequential Wrinkling. Advanced Materials. 24(40), 5441-5446. doi; 10.1002/adma.201201937

What is claimed is:

1. Composite material comprising:
a matrix of a deformable material having a first stiffness; and
particles having a second stiffness different from the first stiffness embedded near a surface of the matrix wherein a deformation of the matrix induces a change in topography of the surface.

2. The composite material of claim 1 wherein the particles are stiffer or softer than the matrix.

3. The composite material of claim 1 wherein the particles are distributed within the matrix either randomly or in an ordered way.

4. The composite material of claim 1 wherein the composite material forms a two-dimensional system.

5. The composite material of claim 4 wherein particle shapes are selected from a group consisting of circular, rectangular, triangular, polygonal or elliptical rods or plates.

6. The composite material of claim 1 wherein the composite material forms a three-dimensional system.

7. The composite material of claim 6 wherein the particles are spherical, ellipsoidal, tetrahedral, or prismatic.

8. The composite material of claim 1 wherein induced deformation of the matrix is uniaxial, biaxial or a complex three-dimensional deformation state.

9. The composite material of claim 1 wherein the matrix material and particles are selected to tune shape, amplitude and frequency of a waveform on the surface.

10. The composite material of claim 1 wherein the matrix material is elastomeric.

11. The composite material of claim 1 wherein tunable surface topography changes light reflection or absorption to change appearance of the surface.

12. The composite material of claim 1 wherein tunable surface topography alters surface roughness in fluid flow to control flow.

13. The composite material of claim 1 wherein tunable surface topography changes coefficient of friction to provide tunable friction control.
